(19) United States
(12) Patent Application Publication
(10) Pub. No.: US 2007/0253080 A1
(43) Pub. Date: Nov. 1, 2007

(54) Optical member unit and projection type display

(75) Inventors: Yoshihiro Yokote, Hirakata-city (JP); Takashi Ikeda, Higashi-Osaka-city (JP); Hiroshi Sekiguchi, Sano-city (JP); Katsumi Endo, Sano-city (JP)

Correspondence Address: NDQ&M WATCHSTONE LLP, 1300 EYE STREET, NW, SUITE 1000 WEST TOWER, WASHINGTON, DC, 20005, US

(73) Assignees: SANYO ELECTRIC CO., LTD., Moriguchi (JP); FUJINON SANO CORPORATION, Sano (JP)

(21) Appl. No.: 11/785,987

(22) Filed: Apr. 23, 2007

(30) Foreign Application Priority Data
Apr. 24, 2006 (JP) JP2006-119281
Sep. 29, 2006 (JP) JP2006-266283
Nov. 15, 2006 (JP) JP2006-309039
Nov. 21, 2006 (JP) JP2006-314302

(51) Int. Cl. G02B 5/04

(52) U.S. Cl. 359/833

(57) ABSTRACT

An optical member unit includes a light transmitting member guiding light emitted by a light source to an imaging optics system by folding the light. The light transmitting member has a refractive index that achieves total reflection of a part of light entering the imaging optics system, the incident angle of the part of light is within the maximum effective incident angle of the light to the imaging optics system. The maximum effective incident angle is determined by the imaging optics system and the refractive index of an incident-side medium that is a medium provided between the imaging optics system and the optical member unit.

### CROSS REFERENCE TO RELATED APPLICATIONS

This application is based upon and claims the benefit of priority from prior Japanese Patent Application No. 2006-119281, filed on Apr. 24, 2006; prior Japanese Patent Application No. 2006-266283, filed on Sep. 29, 2006; prior Japanese Patent Application No. 2006-309039, filed on Nov. 15, 2006; prior Japanese Patent Application No. 2006-314302, filed on Nov. 21, 2006; the entire contents of which are incorporated herein by reference.

### BACKGROUND OF THE INVENTION

1. Field of the Invention

The present invention relates to an optical member unit and a projection type display capable of reflecting light without the need for a special element such as a reflecting film.

2. Description of the Related Art

In an optical system, light emitted from a light source travels varying optical paths into various optics. For example, in a projection type display such as a liquid crystal projector, the projection type display modulates and enters the light emitted from the light source to a dichroic element. The entire display is of large size when the optical path between the light source and the dichroic element lined in a straight. Because of great demands for compact and small sizes, recent projection type displays have been provided with means which folds the light progress direction of the light emitted from the light source to fulfill the demands for the compact and small sizes.

It is effective to use a prism (mainly a triangular prism) as the means which folds the light progress direction of the light. The triangular prism is provided with a reflecting surface on its slanting surface so that the light impinges on the reflecting surface and folds its light progress direction. An example of the above is disclosed in Japanese Patent Publication No. 2005-316446. The Japanese Patent Publication No. 2005-316446 discloses a liquid crystal projector as applied to the optical system, in which the light emitted from the light source folds its optical path by being reflected by the reflecting surface of the prism (or a diagonal surface employed in the Japanese Patent Publication No. 2005-316446). The diagonal surface has a reflecting or mirror cover in order to perform a reflecting function.

The mirror cover is used in the Japanese Patent Publication No. 2005-316446. Since the mirror cover is required to be attached to the prism, the mirror cover may possibly be unable to reflect incident light in a predetermined direction, and unable to guide the light from the light source to a liquid crystal display element (or image forming means employed in the Japanese Patent Publication No. 2005-316446), according to the accuracy of attachment of the mirror cover. The use of the mirror cover to implement the reflecting function also leads to a problem of correspondingly increasing a component count. An increase in the component count of the mirror cover further leads correspondingly to an increase in costs. There is also presented an approach of forming a reflecting film, rather than a mirror cover, on the reflecting surface of the prism. Forming the reflecting film enables the incident light to reflect, while avoiding the problems involved in the component count, the accuracy of attachment, and so on. However, a metal reflecting film such as silver or aluminum for use in the reflecting film has a problem of deteriorating reflectivity by causing optical absorption or doing the like, and the problem of deteriorating atmospheric corrosion resistance by undergoing oxidation, sulfuration, or the like.

Heretofore, an optical member unit including an optical member (hereinafter referred to as a “light guide member”) composed of a light-transmitting member (e.g., glass) and an optical member (e.g., a triangular prism) composed of a light-transmitting member (e.g., glass) has been widely known in general. The triangular prism is the optical member which folds a light progress direction from a light entering direction (light incident direction) to a light exiting direction (light outgoing direction).

The approaches of disposing the triangular prism, which folds the light progress direction from the light incident direction to the light outgoing direction, and the light guide member, as mentioned above, include the approach of providing an air gap having a lower refractive index than the triangular prism and the light guide member between the triangular prism and the light guide member (see “Projector Mame-chishiki,” which is available online on the Internet at http://www.geocities.co.jp/Hollywood-Studio/7057/mame1/mame3.htm, as of Mar. 13, 2006.)

The approach of providing the air gap between the triangular prism and the light guide member is capable of suppressing a decrease in the efficiency of utilization of light or the occurrence of an unevenness of color resulting from a phenomenon that light is not totally reflected but partially passes through the triangular prism or the like.

Here, the approaches of providing the air gap as mentioned above can possibly include the approach of using beads as a spacer. Specifically, a portion of an outer periphery of a light output surface of the light guide member and a portion of an outer periphery of a light incident surface of the triangular prism are bonded with an adhesive containing the beads so that the air gap is formed by the beads between the light output surface of the light guide member and the light incident surface of the triangular prism (e.g., Japanese Patent Publication No. H11-231256).

However, the beads contained in the adhesive scatter light and hence decrease the efficiency of utilization of light of the optical member unit, when the entire areas of the light output surface of the light guide member and the light incident surface of the triangular prism provided within an effective range.

It is therefore desirable that the amount of the adhesive containing the beads be small. However, a small amount of the adhesive containing the beads results in low adhesive strength between the light guide member and the triangular prism.

### SUMMARY OF THE INVENTION

A first aspect of the present invention is an optical member unit including a light transmitting member configured to fold light emitted from a light source, and configured to guide the light into an imaging optics system. In this optical member unit, the light transmitting member has a refractive index that achieves total reflection of a part of light entering the imaging optics system when the incident angle of the part of light is within the maximum effective incident angle of the light to the imaging optics system. In addition, the maximum effective incident angle is determined by the imaging optics system and the refractive index of an incident-side medium provided between the imaging optics system and the optical member unit.

In the above aspect of the present invention, the light transmitting member includes a reflecting surface configured to reflect light, and an output surface through which the light reflected by the reflecting surface exits. Here assume that: nt denotes the refractive index of the light transmitting member; na denotes the refractive index of an outer region outside the light transmitting member; ni denotes the refractive index of the incident-side medium; θi denotes the maximum effective incident angle; θr denotes an incident angle of the light to the output surface; β denotes the angle between the reflecting surface and the output surface; a negative direction denotes a direction in which the light having a reflection angle smaller than an angle Δ is reflected in a plane perpendicular both to the reflecting surface and to the output surface, the reflection angle formed between a direction parallel to the optical axis of the light entering the imaging optics system and a direction of a normal to the reflecting surface, the angle Δ formed between the components in the perpendicular plane; a positive direction denotes a direction in which the light having the reflection angle larger than the angle Δ is reflected; an orthogonal direction denotes a direction of a normal to the imaging optics system; and two conditional inequalities, nt>na and nt>ni, are satisfied. With these assumptions, it is preferable that the light entering the imaging optics system in the positive direction satisfy the conditional inequality, nt×sin(sin−1((ni/nt)×sin θi)+β)/na≧sin 90° when θr<(90−β)°, that the light entering the imaging optics system in the orthogonal direction satisfy the conditional inequality nt×sin β/na≧sin 90°, and that the light entering the imaging optics system in the negative direction satisfy the conditional inequality nt×sin(sin−1((ni/nt)×sin θi)−β)/na≧sin 90° when θr<β°.

In the above aspect of the present invention, it is preferable that the refractive index nt of the light transmitting member satisfy the conditional inequality, nt≧1.59597.

Moreover, it is preferable that the optical member unit in the above aspect of the present invention have the following features. Firstly, the optical member unit includes a first optical member, a second optical member, a low refractive index region forming member and a suspension member. The first optical member has a first light incident surface, a first light output surface and a first light reflecting surface, and composed of a light transmitting material. The second optical member having a second light incident surface, a second light output surface and a second light reflecting surface, and composed of a light transmitting material. The low refractive index region forming member is bonded to a part of an outer periphery of the first light output surface, and a part of an outer periphery of the second light incident surface, and thereby is configured to form a low refractive index region having a refractive index lower than those of the first optical member and the second optical member. The suspension member has an adhesive surface bonded to a part of the first light reflecting surface and a part of the second light reflecting surface, and is configured to suspend the first optical member and the second optical member. At least one of the first optical member and the second optical member folds a light progress direction from a light incident direction to a light outgoing direction that is different from the light incident direction. The suspension member reflects light having passed through the part of the first light reflecting surface.

In the above aspect of the present invention, it is preferable that the suspension member be composed of a glass or a transparent resin.

In the above aspect of the present invention, it is preferable that the suspension member be composed of the same kind of material as those of the first optical member and the second optical member.

In the above aspect of the present invention, it is preferable that the adhesive surface of the suspension member be a mirror surface that reflects light having passed through the first or second light reflecting surface.

In the above aspect of the present invention, it is preferable that the first optical member be a light guide member having a quadrangular pole shape, and that the second optical member be a triangular prism having a triangular pole shape.

In the above aspect of the present invention, it is preferable that the triangular prism has a light reflecting oblique face that guides light entering from the second light incident surface into the second light output surface by changing the light progress direction of the light, and that the suspension member has a side along the light reflecting oblique face in a projection plane parallel to the adhesive surface.

In the above aspect of the present invention, it is preferable that the suspension member has a side along a normal to the light reflecting oblique face in the projection plane parallel to the adhesive surface.

In a second aspect of the present invention, it is preferable that an optical member unit has the following features. Firstly, the optical member unit includes a first optical member, a second optical member, a low refractive index region forming member and a suspension member. Here, the first optical member has a first light incident surface, a first light output surface and a first light reflecting surface, and composed of a light transmitting material. The second optical member having a second light incident surface, a second light output surface and a second light reflecting surface, and composed of a light transmitting material. The low refractive index region forming member is bonded to a part of an outer periphery of the first light output surface, and a part of an outer periphery of the second light incident surface, and is configured to form a low refractive index region having a refractive index lower than those of the first optical member and the second optical member. The suspension member has an adhesive surface bonded to a part of the first light reflecting surface and a part of the second light reflecting surface, and is configured to suspend the first optical member and the second optical member. Moreover, at least one of the first optical member and the second optical member folds a light progress direction from a light incident direction to a light outgoing direction that is different from the light incident direction. Then, the suspension member reflects light having passed through the part of the first light reflecting surface.

In a third aspect of the present invention, an image display includes the optical member unit according to the above aspects.

### BRIEF DESCRIPTION OF THE DRAWINGS

FIG. 1 is a schematic diagram of a liquid crystal projector.

FIG. 2 is an explanatory diagram for a prism and a projection lens.

FIG. 3 is a table showing the relations between F-numbers and refractive indices.

FIG. 4 is an explanatory diagram of a suspension member.

FIG. 5 is a table showing the relations between F-numbers and refractive indices of the prism required to achieve the maximum efficiency of reflection.

FIG. 6 is a schematic diagram of a liquid crystal projector using a DMD.

FIG. 7 is a diagram showing an image display 100 according to a second embodiment of the present invention.

FIG. 8 is a diagram showing a configuration of the image display 100 according to the second embodiment of the present invention.

FIG. 9 is a perspective diagram showing an optical member unit according to the second embodiment of the present invention.

FIG. 10 is a diagram showing one example of the optical member unit according to the second embodiment of the present invention.

FIG. 11 is a diagram showing one example of the optical member unit according to a third embodiment of the present invention.

FIGS. 12A to 12D are diagrams showing variations of the outer shape of a suspension member 160 according to a fourth embodiment of the present invention.

### DETAILED DESCRIPTION OF THE EMBODIMENTS

With reference to the drawings, embodiments of the present invention will be described below. Note that, in the following description of the drawings, the same or similar parts will be denoted by the same or similar reference numerals.

However, it should be noted that the drawings are conceptual, and that ratios of the respective dimensions and the like are different from actual ones. Hence, specific dimensions and the like should be determined by considering the following description. Moreover, it is needless to say that the drawings also include portions in which dimensional relationships and ratios are different from those of one another.

### First Embodiment

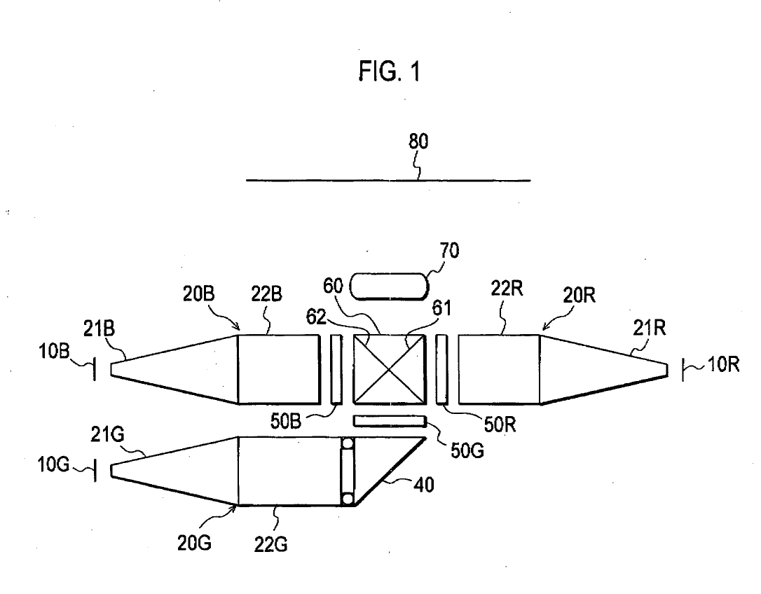

A first embodiment will be described below with reference to the drawings. FIG. 1 shows a liquid crystal projector as an example of a projection type display. As employed hereinafter, the term “red” refers to an optical component for red light, the term “green” refers to an optical component for green light, and the term “blue” refers to an optical component for blue light. Specific examples of the optical components will be described in sequence. The liquid crystal projector shown, for example, in FIG. 1 includes a light source 10 (which is a general term of a red light source 10R, a green light source 10G and a blue light source 10B), a light guide unit 20 (which is a general term of a red light guide unit 20R, a green light guide unit 20G and a blue light guide unit 20B), a prism 40, a liquid crystal display element 50 (which is a general term of a red liquid crystal display element 50R, a green liquid crystal display element 50G and a blue liquid crystal display element 50B), crossed dichroic prisms 60, an imaging optics system 70, and a screen 80. The light guide unit 20 includes a light guide angle control member 21 (which is a general term of a red light guide angle control member 21R, a green light guide angle control member 21G and a blue light guide angle control member 21B), and a light uniformalization member 22 (which is a general term of a red light uniformalization member 22R, a green light uniformalization member 22G and a blue light uniformalization member 22B). The red light source 10R, the green light source 10G and the blue light source 10B are the light source that emits light of wavelengths in the red region (that is, red light), the light source that emits light of wavelengths in the green region (that is, green light), and the light source that emits light of wavelengths in the blue region (that is, blue light), respectively. Although description will be given by taking an instance where an LED (light emitting diode) is applied to the light source, the present invention is not limited to this case.

The red light guide angle control member 21R, the green light guide angle control member 21G and the blue light guide angle control member 21B are rod members in tapered form. Description is herein given by taking an instance where an acrylic resin, a polycarbonate resin, or other light transmitting members such as glass (hereinafter referred to simply as a “light transmitting member”) are applied to a light transmitting member. Red, green and blue light emitted from the light source 10 enters the light guide angle control member 21. Since the light guide angle control member 21 is in the tapered form, the incident light travels in an angled light progress direction, while being totally reflected by a tapered surface. In short, the light travels with its light progress direction angled by the light guide angle control member 21. Since the light guide angle control member 21 is a light transmitting member, the light travels through the light transmitting member.

The red, green and blue light uniformalization members 22R, 22G and 22B are light transmitting members, each of which has the shape of a rectangular parallelepiped. The light uniformalization member 22 is disposed on the outgoing side of the light guide angle control member 21 so that the light, after traveling through the light guide angle control member 21, enters the light uniformalization member 22. As shown in FIG. 1, the cross section of the light uniformalization member 22 of the shape of the rectangular parallelepiped is joined together to the outgoing end of the light guide angle control member 21. When the light transmitting member is applied to the light guide angle control member 21, a light energy distribution can be nonuniform. When the light transmitting member of the shape of the rectangular parallelepiped is used for the light uniformalization member 22, light with various angles can be mixed together to eliminate nonuniformity and hence make the energy distribution uniform.

The prism 40 is the prism composed of a light transmitting member, and a triangular prism is shown in FIG. 1 as an example of the prism 40. In FIG. 1, the prism 40 is used to bend an optical path of green light. In FIG. 1, the green light and blue light follow parallel optical paths, and red light also follows an optical path parallel to the optical paths of the green light and blue light although the red light travels in the direction opposite to the green light and blue light. Consequently, the optical paths of all the light beams of primary colors (hereinafter referred to simply as “RGB”) can be parallel, which contributes to the compact design of the entire liquid crystal projector. At least one of the RGB light beams has to travel a bent optical path in order that the RGB light beams enter the crossed dichroic prisms 60 through three side surfaces thereof. In FIG. 1, the optical path of the green light beam is bent 90 degrees so that the RGB light beams enter the crossed dichroic prisms 60. Although description will be hereinafter given by taking an instance where the optical path of the green light is bent 90 degrees, the optical path may be bent at any angle other than 90 degrees.

The red light passes through the red light uniformalization member 22R. The green light travel the optical path bent by the prism 40, and the blue light passes through the blue light uniformalization member 22B. After that, the red, green and blue light beams enter the red, green and blue liquid crystal display elements 50R, 50G and SOB, respectively, prior to entering the crossed dichroic prisms 60. The liquid crystal display elements 50R, 50G and 50B subject the RGB light beams, respectively, to light modulation to form RGB images. The red, green and blue light beams, after the light modulation by the liquid crystal display elements 50R, 50G and 50B, enter the crossed dichroic prisms 60 through the three side surfaces thereof.

The crossed dichroic prisms 60 are cubic prisms, which are formed of two dielectric multilayered films (or a first dielectric multilayered film 61 and a second dielectric multilayered film 62) as crossing each other. The first dielectric multilayered film 61 is the multilayered film having the optical properties of reflecting only the light of the wavelengths in the blue region and transmitting light of wavelengths in the other regions. The second dielectric multilayered film 62 is the multilayered film having the optical properties of reflecting only the light of the wavelengths in the red region and transmitting light of wavelengths in the other regions. Thus, the blue light entering the crossed dichroic prisms 60 is reflected by the first dielectric multilayered film 61, and the red light entering the crossed dichroic prisms 60 is reflected by the second dielectric multilayered film 62. The green light entering the crossed dichroic prisms 60 passes through the crossed dichroic prisms 60, as it is.

Thus, the crossed dichroic prisms 60 perform color composition to combine the red, green and blue light beams. The imaging optics system 70 serves to project onto the screen 80 the light subjected to the color composition by the crossed dichroic prisms 60. Here, a lens is used for the imaging optics system 70. A projection lens is generally used to display a color image on the screen 80. Description will be hereinafter given by taking an instance where a projection lens 71 is used as the lens for the imaging optics system 70. In the case of a projection type display using a digital micromirror device (DMD) or other cases, a group of relay lenses for guiding light to the DMD or the like, rather than the projection lens, however, is used for the imaging optics system, as will be described later.

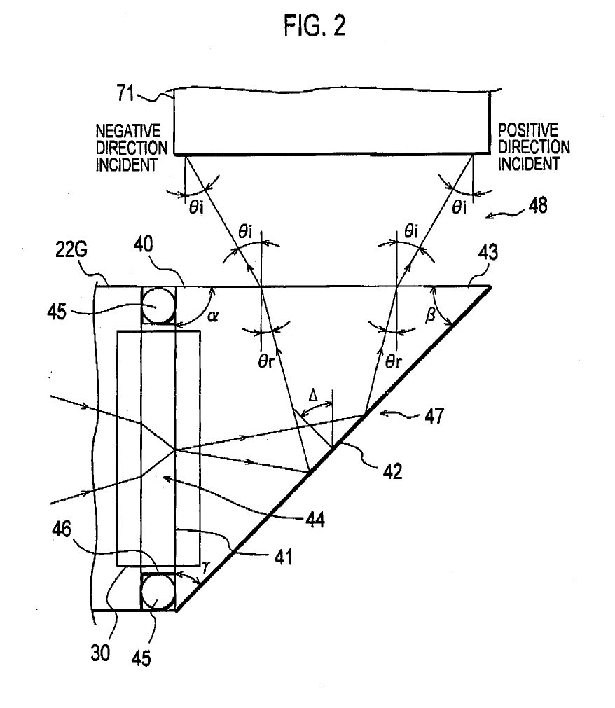

As shown in FIG. 2, the prism 40 has an entry surface 41 through which the green light enter, a reflecting surface 42 that reflects the green light, and an output surface 43 through which the green light exits. Although the triangular prism is shown, for example, in FIGS. 1 and 2, a prism of any shape may be applied, provided that the prism has the entry surface 41, the reflecting surface 42 and the output surface 43. As shown in FIG. 2, a gap region 44 is formed between the green light uniformalization member 22G and the prism 40. The gap region 44 is the region made of a medium with a low refractive index, and an air layer is generally applied to the gap region 44. When the air layer is applied, an air gap is formed between the green light uniformalization member 22G and the prism 40. However, any medium other than the air layer may be applied, provided that the medium has a low refractive index.

A medium with a low refractive index is selected for an outer region 47 of the prism 40 (or the region external to the prism 40 across the reflecting surface 42 taken as a boundary), as in the case of the gap region 44. Accordingly, an air layer is generally applied to the outer region 47 as in the case of the gap region 44, but a layer applied to the outer region 47 is not limited to the air layer. Description will be hereinafter given by taking an instance where media with the same refractive index na (generically called a “low refractive index region”) are used for the gap region 44 and the outer region 47. However, different media may be used for the gap region 44 and the outer region 47. An incident-side medium 48 is also provided between the prism 40 and the projection lens 71, and a material having a lower refractive index than that of the prism 40 (or a material with a refractive index ni) is used for the incident-side medium 48.

Here, the prism 40 is composed of a light transmitting member such as glass, and the refractive index thereof (hereinafter called a “refractive index nt”) is higher than the refractive index na of the low refractive index region. Thus, there is a difference in refractive index between the prism 40 and the low refractive index region. As shown in FIG. 2, the green light traveling through the prism 40 impinges on the reflecting surface 42 at an angle of the reflecting surface 42. If the green light is totally reflected on the reflecting surface 42, the quantity of light for use in image formation can be maximized. However, the reflecting surface 42 does not necessarily have to totally reflect light with every angle, because the incident angle of light available for the imaging optics system 70 is limited. In short, the image formation can be accomplished by the total reflection of light with angles available for the imaging optics system 70, that is, available light. The prism 40 can adopt two approaches for enhancing the efficiency of reflection: the approach of providing a large difference in refractive index between the prism 40 and the low refractive index region; and the approach of controlling the angle of incident light to the reflecting surface 42 of the prism 40 so that the incident angle falls within the range of angles of total reflection defined by the refractive indices of the prism 40 and the outer region 47.

For an optical system in a stage preceding the prism 40, it is difficult to adopt the latter one of the above two approaches for enhancing the efficiency of reflection, that is, to completely control the incident angle of the prism 40 to reflecting surface 42, so that some light quantity losses can possibly occur. The projection type display according to the present invention is therefore configured to control the refractive index nt of the prism 40 and thereby widen the angle of reflection to the reflecting surface 42. Specifically, a high-index material with a high refractive index is used for the prism 40. Using the material with the high refractive index for the prism 40 makes it possible to widen the angle of total reflection to the reflecting surface 42, regardless of the incident angle of green light entering the entry surface 41.

In this embodiment of the present invention, the minimum refractive index required for the prism 40 (or a minimum refractive index Min) is specified according to the F-number of the imaging optics system 70. The refractive index nt of the prism 40 is suitably controlled to satisfy an inequality Min≦nt and thereby enhance the efficiency of reflection without using a special element such as a reflecting film or a reflecting cover.

The green light reflected from the reflecting surface 42 of the prism 40 is subjected to color composition by the crossed dichroic prisms 60 and finally enters the projection lens 71. Of the green light emitted from the light source 10G, the light with an angle greater than a maximum effective incident angle specified according to the F-number of the projection lens 71 does not contribute to an image finally projected onto the screen 80. The display of the present invention is therefore configured to enhance the efficiency of reflection of the green light with an angle equal to or less than the maximum effective incident angle of the projection lens 71 to the green light entering the prism 40.

In FIG. 2, θr represents an incident angle of the prism 40 to the output surface 43, and θi represents the maximum effective incident angle of the projection lens 71. In FIG. 2, α represents an angle formed between the entry surface 41 and the output surface 43 of the prism 40, β represents an angle formed between the reflecting surface 42 and the output surface 43, and γ represents an angle formed between the entry surface 41 and the reflecting surface 42. In this case, the maximum effective incident angle θi of the projection lens 71 is equal to a refraction angle of the green light exiting through the output surface 43. The prism 40 has the angles α, β and γ(α+β+γ=180°). When the triangular prism of the shape of a right isosceles triangle is used, α=90° and β=γ=45°.

In this case, when the conditions for total reflection are satisfied, the green light within the range of the maximum effective incident angle θi is totally reflected by the reflecting surface 42 of the prism 40. The conditions are satisfied by controlling the refractive index nt of the prism 40 so that conditional inequalities given below are satisfied. As employed herein, a “negative direction” refers to a direction in which the light having a reflection angle smaller than an angle Δ is reflected in a plane perpendicular both to the reflecting surface 42 and to the output surface 43. Here, the reflection angle is formed between a direction parallel to the optical axis of the light entering the projection lens 71 and a direction of a normal to the reflecting surface 42. Moreover, the angle Δ is formed between the components in the plane perpendicular both to the reflecting surface 42 and to the output surface 43. A “positive direction” refers to a direction in which the light having the reflection angle larger than the angle Δ is reflected. An “orthogonal direction” refers to a direction orthogonal to an entry surface of the projection lens 71. Incidentally, the conditional inequalities given below are supposed to satisfy two conditional inequalities, that is, nt>na and nt>ni.

The conditions for total reflection are as follows. The light entering from the positive direction satisfies the condition that nt×sin(sin−1((ni/nt)×sin θi)+β)/na≧sin 90° when θr<(90−β)°. The light entering from the orthogonal direction satisfies the condition that nt×sin β/na≧sin 90°. The light entering from the negative direction satisfies the condition that nt×sin(sin−1((ni/nt)×sin θi)−β)/na≧sin 90° when θr<β°.

In the above inequalities, variable factors to determine the refractive index nt are na, ni, β, and θi. As for na and ni of these factors, a given medium and incident-side medium can be selected previously for the low refractive index region. Also as for β, the shape of the prism 40 can be selected previously. Since air is generally selected as the medium for the low refractive index region, na is equal to 1.0 (na=1.0). Since air is likewise selected as the incident-side medium 48, ni is equal to 1.0 (ni=1.0). Since the prism of the shape of the right isosceles triangle is employed as the prism 40, β is equal to 45 (degrees) (β=45°). Thus, na, ni and β can be used as fixed factors, and θi is substantially the variable factor to determine the refractive index nt. In other words, the refractive index nt of the prism 40 is determined according to the maximum effective incident angle Si of the projection lens 71. As is apparent from the above inequalities, the wider range of the maximum effective incident angle θi requires proportionally the higher refractive index at of the prism 40.

The maximum effective incident angle θi of the projection lens 71 is specified according to the F-number of the projection lens 71. In other words, the smaller F-number of the projection lens 71 leads to the wider range of the maximum effective incident angle θi. Thus, the smaller F-number of the projection lens 71 requires the higher refractive index nt of the prism 40, and the larger F-number permits the lower refractive index nt. Besides the F-number of the projection lens 71, the refractive index ni of the incident-side medium 48 may be used as a variable factor for the maximum effective incident angle θi. Here, the maximum effective incident angle θi is specified according to the F-number of the projection lens 71 because ni is set to 1.0 (ni=1.0). When ni is variable, the maximum effective incident angle θi, however, is specified according to the F-number of the projection lens 71 and the refractive index ni of the incident-side medium 48.

As shown in FIG. 2, the angle Δ formed by the direction parallel to the optical axis of the light entering the projection lens 71 and the direction of the normal to the reflecting surface 42 is used to determine the “positive direction” and the “negative direction.” When the prism 40 is of the shape of the right isosceles triangle (that is, α=90° and β=γ=45°) and coincides with the direction of the normal to the projection lens 71 and the direction of the optical axis of the light entering the projection lens 71, the angle Δ is equal to the angle of reflection to the reflecting surface 42 (i.e., 45 degrees). Consequently, in this case, the “positive direction” is the direction in which the light is reflected when the angle of reflection to the reflecting surface 42 is greater than 45 degrees, and the “negative direction” is the direction in which the light is reflected when the angle of reflection is less than 45 degrees.

For total reflection by the reflecting surface 42, the required minimum refractive index Min of the prism 40 can be specified according to the maximum effective incident angle θi specified according to the F-number of the projection lens 71, as described above.

Incidentally, the refractive index of the prism 40 is controlled according to the F-number of the projection lens 71 to thereby achieve an improvement in the efficiency of reflection of green light by the reflecting surface 42. The display of the present invention is configured to determine the refractive index nt of the prism 40 according to the F-number of the projection lens 71. Thereby, the display has also the function of reflecting only green light that contributes to image formation required for the projection lens 71, and getting rid of unnecessary green light. In other words, the display is configured to control the refractive index nt of the prism 40 according to the F-number of the projection lens 71 in order for the refractive index nt to approach the minimum refractive index Min. Thereby, the display has not only the function of changing the optical path of green light, but also the aspect of having the filtering function of selectively reflecting only light that contributes to the formation of an image to be projected onto the screen 80.

When the reflecting surface 42 of the prism 40 has only the function of reflecting light (e.g., in a situation where a reflecting film or the like is formed to reflect light or in other situations), light other than light essentially required for image formation can possibly enter the projection lens 71. If so, unnecessary light is irregular reflected light and thus results in light detrimental to image formation by the projection lens 71 (i.e., so-called stray light), so that the light has the adverse effect of reducing contrast upon an image finally formed on the screen 80. This embodiment of the present invention selects and employs the prism 40 having the refractive index nt which is a value close to the minimum refractive index Min according to the F-number of the projection lens 71. Since light with an angle greater than the maximum effective incident angle θi specified according to the F-number of the projection lens 71 is a factor causing the stray light, it is desirable that the light should pass through the reflecting surface 42 of the prism 40 without being reflected thereby. Thus, the prism 40 having the refractive index nt which is the value close to the minimum refractive index Min according to the F-number of the projection lens 71 is selected to enhance the efficiency of reflection of only light within the range of the maximum effective incident angle θi. In other words, control is performed so that the light not required for the image formation is not actively reflected but is eliminated (or passes through the reflecting surface 42). Consequently, the prism 40 having the refractive index nt which is the value dose to the minimum refractive index Min according to the F-number of the projection lens 71 is selected to perform two functions: the light reflecting function and the filtering function.

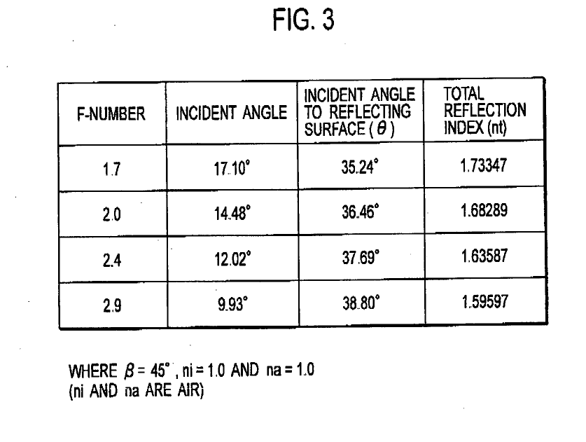

Description will be given with reference to FIG. 3 of the minimum refractive index Min required for the prism 40 (provided that β=45°, ni=1.0, and na=1.0, or provided that ni and na are air). In FIG. 3, the maximum effective incident angle θi is 17.10 degrees when the F-number of the projection lens 71 is 1.7. Specifically, since only incident light with an incident angle of 17.10 degrees or less to the projection lens 71, contributes to the formation of an image to be projected onto the screen 80, only the incident light within this range is totally reflected by the reflecting surface 42 of the prism 40. Here, the minimum refractive index Min derived from the above inequalities is 1.73347. When the F-number of the projection lens 71 is 1.7, the refractive index nt of the prism 40 required for total reflection is therefore equal to or higher than 1.73347 (nt≧1.73347). In a table of FIG. 3, the term “incident angle of reflecting surface” refers to the incident angle of incident light to the reflecting surface 42 of the prism 40.

Likewise, the conditions are satisfied that the refractive index nt is equal to or higher than 1.68289 (nt≧1.68289) when the F-number is 2.0, the refractive index nt is equal to or higher than 1.63587 (nt≧1.63587) when the F-number is 2.4, or the refractive index nt is equal to or higher than 1.59597 (nt≧1.59597) when the F-number is 2.9. In this manner, light within the range of the maximum effective incident angle θi specified by the F-number of the projection lens 71 totally reflects. A prism with a refractive index nt of 2.0017 at the maximum can be used as the prism 40. TAFD 25 (nt=1.90366) commercially available from HOYA Corporation or the like is suitably used as a specific glass material.

Incidentally, a part of the reflected light can possibly be reflected toward the entry surface 41, not the output surface 43, corresponding to the incidence angle of the reflecting surface 42. In the display of the present invention, the low refractive index region is formed by the gap region 44, as shown in FIG. 2. When the low refractive index region is formed, a difference arises between the refractive index nt of the prism 40 and the refractive index na of the low refractive index region, so that a part of a green light reflected toward the entry surface 41 do not pass through the entry surface 41 but is again reflected toward the output surface 43. Even if the part of the green light reflected from the reflecting surface 42 go toward the entry surface 41, the low refractive index region can return the part of the green light to the output surface 43, and thus suppress the occurrence of light quantity losses.

A spacer 45 is interposed between the green light uniformalization member 22G and the prism 40 in order to form the low refractive index region. The low refractive index region can be formed by filling a medium with a low refractive index (or a medium with the refractive index na) into gap between the green light uniformalization member 22G and the prism 40 with the spacer 45 in between. In particular, when the low refractive index region is the air layer, the low refractive index region can be formed merely by interposing the spacer 45 between the green light uniformalization member 22G and the prism 40 without having to use a special medium. Description will be hereinafter given, provided that the low refractive index region is the air layer.

Since the light transmitting member is used for the green light uniformalization member 22G as previously mentioned, outgoing green light traveling from the green light uniformalization member 22G to the low refractive index region is refracted under the influence of the difference in refractive index. Since the light transmitting member is likewise used for the prism 40, an incoming green light traveling from the low refractive index region to the prism 40 is again refracted. Thus, it is necessary to strictly control gap between the green light uniformalization member 22G and the prism 40. The reason is as follows. Since the green light travels from one medium to another while being repeatedly refracted as mentioned above, the green light is incapable of being refracted at a predetermined angle unless strict control is performed on the gap between the green light uniformalization member 22G and the prism 40. Here, the spacers 45 for gap control each having a spherical shape (e.g., beads or the like), and are disposed in the four corners of a linkage part between the green light uniformalization member 22G and the prism 40. Besides the above, a narrow, cylindrical member, for example, may be used for the spacer 45 and the spacers 46 are disposed in two places, respectively, on the end between the green light uniformalization member 22G and the prism 40.

Preferably, the low refractive index region between the green light uniformalization member 22G and the prism 40 is an enclosed space. When the low refractive index region is the air layer, the low refractive index region is a passageway for green light of short wavelengths (incidentally, the same goes for blue light and red light). If a foreign substance such as dust and others enters this region, the green light can possibly be affected by the foreign substance. Thus, a sealing member 46 is formed in order that the low refractive index region between the green light uniformalization member 22G and the prism 40 is in an enclosed state. The sealing member 46 is formed so as to enclose the inside of the spacer 45, and the low refractive index region having the enclosed space is formed within the sealing member 46.

Preferably, the green light uniformalization member 22G and the prism 40 are linked together with the low refractive index region in between. Here, a suspension member 30 is used although the approach of using an adhesive for the spacer 45 or the sealing member 46 to bond them together can be adopted for linkage. A light-transmitting plate member is employed for the suspension member 30. Most preferably, a light transmitting member of the same type as the green light uniformalization member 22G and the prism 40 (e.g., a member with an equal refractive index, such as a glass member of the same type) is employed. The suspension member 30 is bonded to the green light uniformalization member 22G and the prism 40 with an adhesive or the like to thereby link them together. The suspension member 30, as bonded to the green light formalization member 22G and the prism 40, is utilized to firmly link them. When a light transmitting member of a different type is employed, a bonded surface can possibly be peeled off or do the like under the influence of a difference in coefficient of thermal expansion due to a rise in temperature, for example. Preferably, the light transmitting member of the same type is therefore employed.

As shown in FIG. 2, the greater part of the suspension member 30 is the bonded surface to the green light uniformalization member 22G and the prism 40. Although one suspension member 30 is shown in FIG. 2, the same suspension member 30 is bonded on the opposite side. Thus, the green light uniformalization member 22G and the prism 40 are linked on both sides, so that the strength of linkage becomes higher.

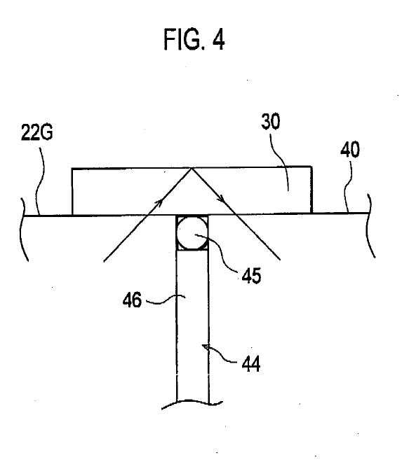

Here, most of green light traveling through the green light uniformalization member 22G enters the low refractive index region, but a part of the green light can possibly enter the suspension member 30 as shown in FIG. 4. When the part of the green light entering the suspension member 30 leaks out, the part of the green light becomes lost and can hence cause light quantity losses. However, the display of the present invention can prevent such leakage of light, even if the part of the green light enters the suspension member 30. Specifically, the suspension member 30 has a high index because the light transmitting member of the same type as the prism 40 is used for the suspension member 30. Thus, a large difference exists between the refractive index of the low refractive index region and the refractive index of the suspension member 30, so that the part of the green light entering the suspension member 30 is reflected by the opposite surface to the bonded surface of the suspension member 30. Thus, the green light is returned to the prism 40 without leaking out.

Although the description has been given with reference to FIG. 1 of the liquid crystal projector configured to bend the optical path of green light, the liquid crystal projector may be configured to bend the optical path of blue or red light. The liquid crystal projector may be configured to bend the optical paths of light of two or three of the RGB colors, rather than the optical path of light of one of the RGB colors. Although the description has been given provided that the LED is employed for the light source, a discharge lamp, a laser light source, an EL (electroluminescence) device, or the like, for example, may be employed.

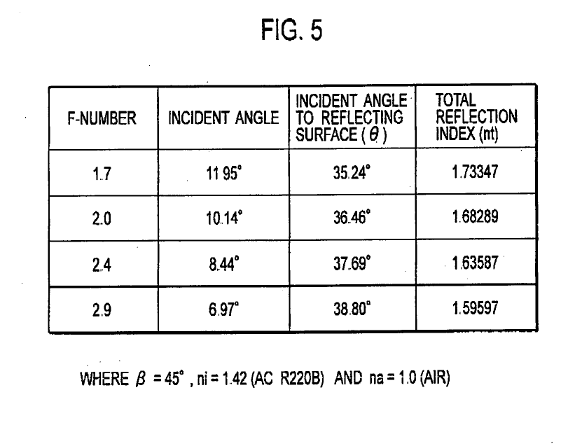

With the configuration of the projection type display, the outer region 47 of the prism 40 is typically disposed in the air, aside from situations where it is placed in peculiar environments. However, the air layer is not necessarily formed in the gap region 44 and a desired medium may be sealed in the gap region 44, since the gap region 44 between the green light uniformalization member 22G and the prism 40 is a closed space enclosed by the spacers 45. For example, an optical adhesive or the like may be filled into the gap region 44 so as to act as a member for adjusting the refractive index FIG. 5 shows the relation between the F-number of the imaging optics system 70 and the refractive index of the prism 40 required to achieve the maximum efficiency of reflection when the gap region 44 is filled with an optical adhesive AC R220B (commercially available from Marubeni Chemix Corporation).

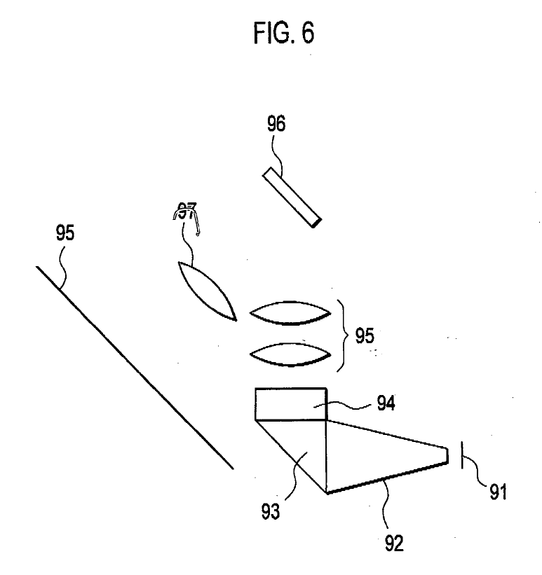

Description will now be given with reference to FIG. 6 of the projection type display using the DMD. In FIG. 6, the projection type display using the DMD includes a light source 91, a light guide angle control member 92, a prism 93, a light uniformalization member 94, an imaging optics system 95, a DMD 96, a projection lens 97, and a screen 98. Of these components, the light guide angle control member 92, the prism 93, the light uniformalization member 94, the projection lens 97 and the screen 98 perform the same functions as previously mentioned. The light source 91 is the light source that oscillates blue light, green light and red light. The light source 91 is a light source for oscillating the RGB. The imaging optics system 95 is composed of a group of relay lenses to focus onto the DMD 96 blue, green and red light exiting from the light uniformalization member 94. The DMD 96 is a micromirror corresponding to each pixel. The DMD 96 performs light modulation by performing on-off control on the tilt direction of the micromirror.

The projection type display using the DMD is also capable of reflecting required light without having to form a reflecting film or the like, by controlling the refractive index of the prism 93. Specifically, since only light with an angle equal to or less than the maximum effective incident angle specified by the F-number of the group of relay lenses of the imaging optics system 95 for focusing an image onto the DMD 96 contributes to image formation, the prism 93 is provided with such a refractive index that only the light is selectively totally reflected. Moreover, the refractive index of the prism 93 is controlled so that light quantity losses fall within a margin of error. The refractive index of the prism 93 is suitably controlled to thereby enable total reflection without having to form a reflecting film or the like on the prism 93 and also enable suppressing light quantity losses. The projection type display is not limited to using the DMD, and the present invention may be applied to any projection type display such as a reflection type liquid crystal display element.

### Second Embodiment

(Image Display)

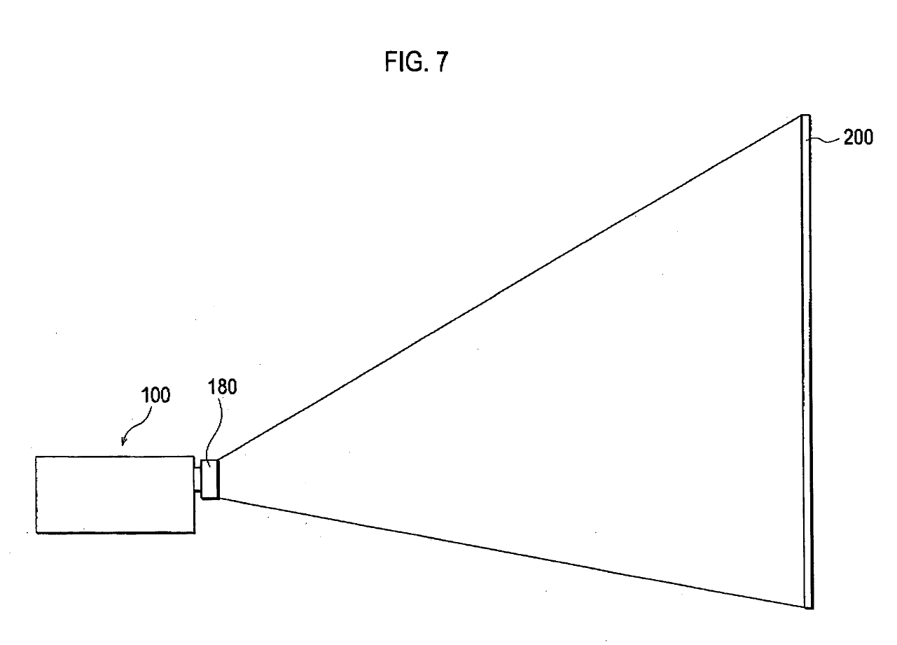

An image display according to a second embodiment of the present invention will be described below with reference to the drawings. FIG. 7 is a diagram showing an image display 100 according to the second embodiment of the present invention.

As shown in FIG. 7, the image display 100 includes a projection lens 180, and displays an image magnified by the projection lens 180 on a screen 200.

Note that the image display 100 will be described as a three-plate type projector in the second embodiment, the image display 100 is not limited to this type. For example, the image display 100 may be a single-plate type projector, or a back projection television. Alternatively, the image display 100 may be a viewfinder used for a camera.

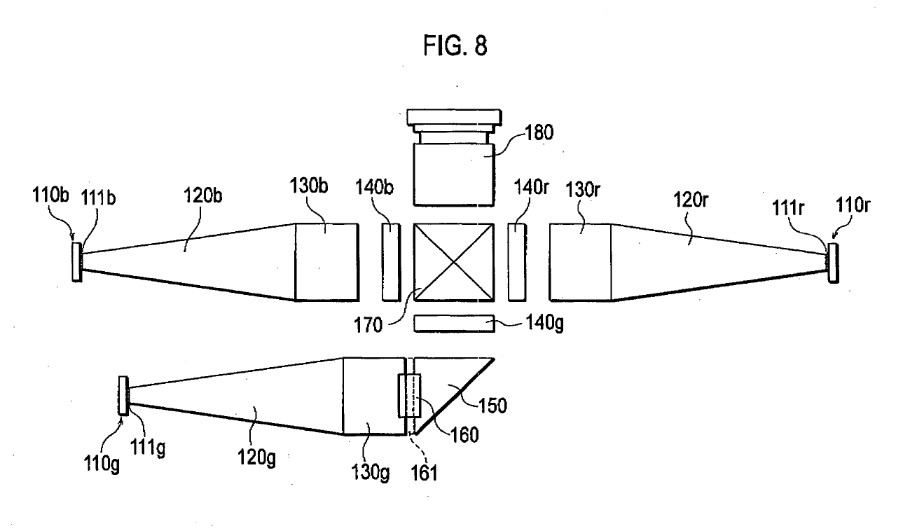

A configuration of the image display 100 will be described below by referring to the drawings. FIG. 8 is a diagram showing the image display 100 according to the second embodiment of the present invention. Although FIG. 8 only shows the components related to the present invention, the image display 100 may include other optical members (for example, a relay lens and the like), as a matter of course.

As shown in FIG. 8, the image display 100 includes a plurality of light sources 110 (light sources 110r, 110g and 110b), a plurality of tapered rods 120 (tapered rods 120r, 120g and 120b), a plurality of light guide members 130 (light guide members 130r, 130g and 130b), a plurality of liquid crystal panels 140 (liquid crystal panels 140r, 140g and 140b), a triangular prism 150, a dichroic prism 170 and a projection lens 180.

The light source 110r is a light source emitting red light, and includes a red LED array 111r having a plurality of red LEDs in array. Similarly, the light source 110g is a light source emitting green light, and includes a green LED array 111g having a plurality of green LEDs in array. Then, the light source 110b is a light source emitting blue light, and includes a blue LED array 111b having a plurality of blue LEDs in array.

The tapered rod 120r has a tapered shape in which a light output surface area is larger in area than a light incident surface, and is an optical member for reflecting the red light emitted from the light source 110r by the side face of the tapered rod 120r.

Similarly, the tapered rod 120g has a tapered shape in which a light output surface area is larger in area than a light incident surface, and is an optical member for reflecting the green light emitted from the light source 110g by the side face of the tapered rod 120g.

Moreover, the tapered rod 120b has a tapered shape in which a light output surface area is larger in area than a light incident surface, and is an optical member for reflecting the blue light emitted from the light source 110b by the side face of the tapered rod 120b.

The light guide member 130r is composed of a light transmitting material, and is a solid optical member with a quadrangular pole shape. Incidentally, the light transmitting material is, for example, a glass, a transparent resin such as an acrylic resin and a polycarbonate resin, or the like. In addition, the quadrangular pole shape includes a tapered shape, of course. The light guide member 130r is the optical member for guiding the red light emitted from the light output surface of the tapered rod 120r into the liquid crystal panel 140r, by reflecting the red light by side faces (called light reflecting surfaces, below) of the light guide member 130r.

Similarly, the light guide member 130g is made of a light transmitting material, and is a solid optical member with a quadrangular pole shape. The light guide member 130g is the optical member for guiding the green light emitted from the light output surface of the tapered rod 120g into the liquid crystal panel 140g (the triangular prism 150), by reflecting the green light by side faces (called light reflecting surfaces, below) of the light guide member 130g. Incidentally, the quadrangular pole shape includes a tapered shape, of course.

Moreover, the light guide member 130b is made of a light transmitting material, and is a solid optical member with a quadrangular pole shape. The light guide member 130b is the optical member for guiding the blue light emitted from the light output surface of the tapered rod 120g into the liquid crystal panel 140b, by reflecting the blue light by side faces (called light reflecting surfaces, below) of the light guide member 130b. Incidentally, the quadrangular pole shape includes a tapered shape, of course.

Note that the light guide members 130r, 130g and 130b will be collectively called a light guide member 130 if necessary, since they have the same structure.

In response to a video signal from a drive circuit (not illustrated), the liquid crystal panel 140r modulates and emits red light to the dichroic prism 170. Similarly, in response to a video signal from a drive circuit (not illustrated), the liquid crystal panel 140g modulates and emits green light to the dichroic prism 170. Moreover, in response to a video signal from a drive circuit (not illustrated), the liquid crystal panel 140b modulates and emits blue light to the dichroic prism 170.

The triangular prism 150 is composed of a light transmitting material, and is a solid optical member with a triangular pole shape. The triangular prism 150 is the optical member for guiding the green light emitted from the light output surface of the light guide member 130g into the liquid crystal panel 140g by changing the light progress direction of the green light. The triangular prism 150 is provided for the purpose of downsizing the image display 100 by changing the light progress direction of the green light emitted by the light source 110g.

Moreover, an air gap 161 is provided between the light output surface of the light guide member 130g and the light incident surface of the triangular prism 150 so that the green light is allowed to be totally reflected.

In addition, a suspension member 160 is bonded to a part of the light reflecting surface of the light guide member 130g, and a corresponding part of the light reflecting surface of the triangular prism 150. The suspension member 160 has a plate-like shape composed of a light transmitting material, and suspends the light guide member 130g and the triangular prism 150.

The suspension member 160 is composed of the same kind of material as those for the light guide member 130 and the triangular prism 150.

Incidentally, in the second embodiment, “the same kind” means the same kind of material. For example, when the light guide member 130 and the triangular prism 150 are composed of a transparent resin, the suspension member 160 is also composed of a transparent resin. Instead, when the light guide member 130 and the triangular prism 150 are composed of a glass, the suspension member 160 is also composed of a glass. Here, the suspension member 160 may have the refractive index different from those of the light guide member 130 and the triangular prism 150.

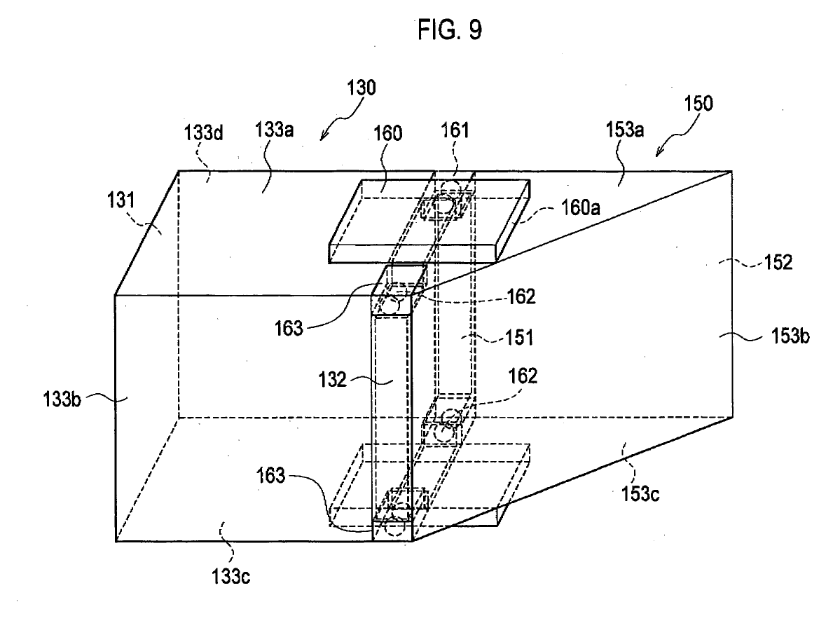

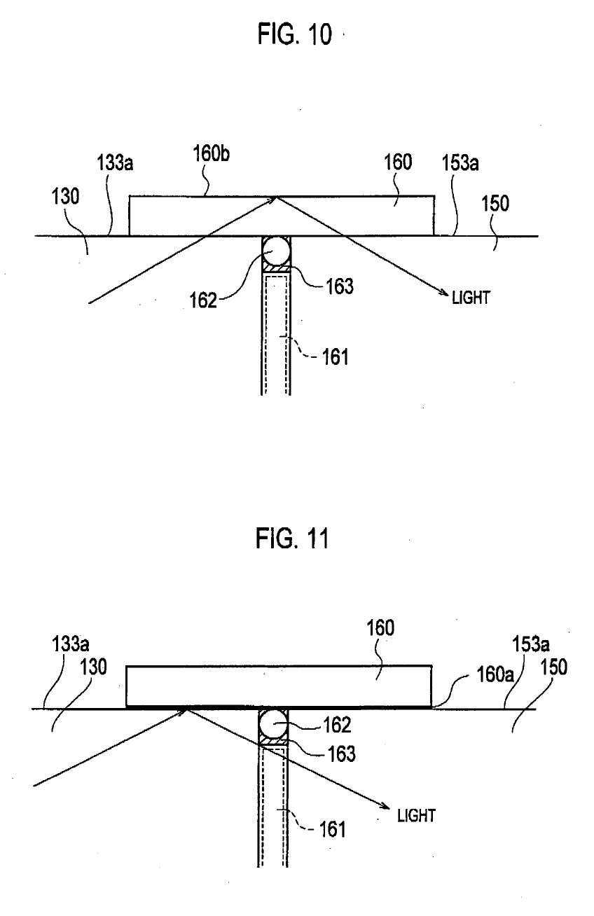

A more detailed description for a peripheral configuration (that is, an optical member unit) around the air gap 161 will be provided later (see FIGS. 9 and 10).

The dichroic prism 170 combines the red light from the liquid crystal panel 140r, the green light from the liquid crystal panel 140g, and the blue light from the liquid crystal panel 140b. Specifically, the dichroic prism 170 reflects the red light from the liquid crystal panel 140r and the blue light from the liquid crystal panel 140b in directions to the projection lens 180, while allowing the green light from the liquid crystal panel 140g to pass through the dichroic prism 170.

The projection lens 180 magnifies images displayed respectively on the liquid crystal panel 140r, the liquid crystal panel 140g and the liquid crystal panel 140b, thereby allowing the magnified images to be displayed on the screen 200. Precisely, the projection lens 180 allows the combined light beams by the dichroic prism 170 to be projected on the screen 200 therethrough.

(Optical Member Unit)

Hereinafter, the optical member unit according to the second embodiment of the present invention will be described by referring to the drawings. FIG. 9 is a perspective view showing the optical member unit according to the second embodiment of the present invention. Note that the optical member unit in the second embodiment is a unit composed of the light guide member 130, the triangular prism 150 and the suspension member 160.

As shown in FIG. 9, the light guide member 130 includes a light incident surface 131 through which light enters thereinside, a light output surface 132 through which the light exits, and a plurality of light reflecting surfaces 133 (light reflecting surfaces 133a to 133d) each provided so as to lie between one side of the outer periphery of the light incident surface 131 and a corresponding side of the outer periphery of the light output surface 132. The light reflecting surfaces 133 totally reflect the light entering from the light incident surface 131, and thereby guiding the light into the light output surface 132.

The triangular prism 150 includes a light incident surface 151 through which light enters thereinside, a light output surface 152 through which the light exit, and a plurality of light reflecting surfaces 153 (light reflecting surfaces 153a to 153d) each provided so as to lie between one side of the outer periphery of the light incident surface 151 and a corresponding side of the outer periphery of the light output surface 152.

Here, a surface direction of the light incident surface 151 is different from a surface direction of the light output surface 152. In other words, the triangular prism 150 folds the light progress direction from a light entering direction (light incident direction) to a light outgoing direction (light outgoing direction).

Moreover, the light reflecting surfaces 153 totally reflects the light entering from the light incident surface 151, and thereby guides the light to the light output surface 152. The light reflecting surface 153b, particularly, is an optical reflecting surface for changing the light progress direction from the light incident direction to the light outgoing direction, by totally reflecting the light entering from the light incident surface 151.

The suspension member 160 includes an adhesive surface 160a bonded to parts of the respective light reflecting surfaces 133 and 153, and suspends the light guide member 130g and the triangular prism 150.

Incidentally, in the second embodiment, the suspension member 160 is composed of a first suspension member bonded to the parts of the light reflecting surfaces 133a and 153a, and a second suspension member bonded to the parts of the light reflecting surfaces 133c and 153c.

Here, a region having the refractive index lower than those of the light guide member 130 and the triangular prism 150, that is, the air gap 161 is provided between the light output surface 132 of the light guide member 130 and the light incident surface 151 of the triangular prism 150.

To be more precise, in order to ensure the width of the air gap 161, beads 162 are bonded, with an adhesive 163, to a part of the outer periphery of the light output surface 132 and a corresponding part of the outer periphery of the light incident surface 151. The beads 162 are members for forming the air gap 161 in this way.

Note that each of the beads 162 has a spherical shape made of a borosilicate glass, for example, and its diameter is approximately 20 μm. In addition, the adhesive 163 is an adhesive that hardens when being irradiated with a ultra violet (UV) beam, and has the refractive index that becomes approximately 1.4 to 1.5 (25 C.°) after having hardened. Moreover, the beads 162 are contained in advance in the adhesive 163.

It is preferable that pieces of the adhesive 163 containing the beads 162 be provided to the four corners of the outer peripheries of the light output surface 132 and the light incident surface 151.

Providing the air gap 161 between the light output surface 132 of the light guide member 130 and the light incident surface 151 of the triangular prism 150 as described above prevents a reduction in efficiency of utilization of light, the reduction caused by a phenomenon that light emitted from the light output surface 132 of the light guide member 130 is not totally reflected. For example, after being emitted from the light output surface 132 of the light guide member 130, light reflected by the light reflecting surface 153b of the triangular prism 150 may partially enter the light reflecting surfaces 133 of the light guide member 130 at a large incident angle, if the air gap 161 is not provided. In this case, since the conditions for the total reflection are not satisfied, the light emitted from the light output surface 132 of the light guide member 130 partially passes through the light reflecting surfaces 133 of the light guide member 130, and this reduces the efficiency of utilization of light.

FIG. 10 is a diagram showing one example of the optical member unit according to the second embodiment of the present invention. Note that FIG. 10 is the diagram viewed from a lateral side of the optical member unit.

As shown in FIG. 10, the suspension member 160 suspends the light guide member 130 and the triangular prism 150. In addition, the suspension member 160 has the plate-like shape composed of the light transmitting material, as described above.

Here, the suspension member 160 is bonded to the part of the light reflecting surface 133a of the light guide member 130, and the light reflecting surface 153a of the triangular prism 150. Moreover, the suspension member 160 has the refractive index higher than the atmosphere, that is, the refractive index approximately equal to those of the light guide member 130 and the triangular prism 150.

Accordingly, as shown in FIG. 10, a part of the light entering from the light incident surface 131 is not totally reflected by the part of the light reflecting surface 133a bonded to the suspension member 160, and thereby passes through the part of the light reflecting surface 133. Then, the light having passed through the part of the light reflecting surface 133 is totally reflected by the reflecting surface 160b of the suspension member 160. Moreover, the light is not totally reflected by the part of the light reflecting surface 153a bonded to the suspension member 160, and thereby passes through the part of the light reflecting surface 153a.

(Effects)

In the optical member unit of the second embodiment of the present invention, the suspension member 160 is bonded to the parts of the light reflecting surfaces 133 and 153 of the light guide member 130 and the triangular prism 150, and thus suspends the light guide member 130 and the triangular prism 150.

In this way, the suspension member 160 increases the adhesive strength between the light guide member 130 and the triangular prism 150. This makes it possible to maintain the sufficiently adhesive strength between the light guide member 130 and the triangular prism 150 even when the area is reduced where the adhesive 163 containing the beads 162 is provided to the light output surface 132 and the light incident surface 151.

Therefore, it is possible to reduce the area to which the adhesive 163 containing the beads 162 is provided to the light reflecting surface 133a and the light reflecting surface 163a, and thereby to suppress reduction in efficiency of use of light, the reduction caused by the beads 162 contained in the adhesive 163.

Moreover, since the suspension member 160 is composed of the light transmitting material (a transparent resin or a glass), the light having passed through the part of the light reflecting surface 133a bonded to the suspension member 160 is reflected by the reflecting surface 160b of the suspension member 160.

This configuration can also suppress the reduction in the efficiency of utilization of light, the reduction caused by the suspension member 160 even when the suspension member 160 is provided for the purpose of increasing the adhesive strength between the light guide member 130 and the triangular prism 150.

Furthermore, in the optical member unit according to the second embodiment of the present invention, the suspension member 160 is composed of the same kind of material as those of the light guide member 130 and the triangular prism 150. This increases the adhesive strength between the part of the light reflecting surface 133a of the light guide member 130 and the suspension member 160, and the adhesive strength between the part of the light reflecting surface 153a of the triangular prism 150 and the suspension member 160.

Accordingly, the suspension member 160 further increases the adhesive strength between the light guide member 130 and the triangular prism 150, and thereby the area to which the adhesive 163 containing the beads 162 is provided to the light reflecting surface 133a and the light reflecting surface 153a can be further reduced.

### Third Embodiment

Hereinafter, a third embodiment of the present invention will be described with reference to the drawings. Note that a description will be provided mainly for different points between the second and third embodiments.

To be more precise, since the suspension member 160 according to the aforementioned second embodiment is composed of the light transmitting material, the light having passed through the light reflecting surface 133a of the light guide member 130 is totally reflected by the reflecting surface 160b of the suspension member 160.

In contrast to this, a suspension member 160 according to the third embodiment includes an adhesive face 160a that is a mirror face reflecting light. Note that the suspension member 160 does not required to be composed of a light transmitting material, and may be composed of any kind of material in the third embodiment, because the adhesive surface 160a is the mirror surface.

FIG. 11 is a diagram showing one example of an optical member unit according to the third embodiment of the present invention. Incidentally, FIG. 11 is the diagram viewed from a lateral side of the optical member unit.

As shown in FIG. 11, the suspension member 160 suspends a light guide member 130 and a triangular prism 150. Moreover, the adhesive surface 160a of the suspension member 160 is the mirror surface that reflects light.

Here, as is the case with the aforementioned second embodiment, the suspension member 160 is bonded to a part of the light reflecting surface 133a of the light guide member 130 and a part of the light reflecting surface 153a of the triangular prism 150. Accordingly, if the adhesive surface 160a is not the mirror surface, light is not reflected by the part of the light reflecting surface 133a of the light guide member 130.

In contrast, as shown in FIG. 11, light is also reflected by the part of the light reflecting surface 133a of the light guide member 130 in the third embodiment, because the adhesive surface 160a of the suspension member 160 is the mirror face.

(Effect)

According to the optical member unit of the third embodiment of the present invention, the adhesive surface 160a of the suspension member 160 is composed of the mirror surface, and thereby light is also reflected by the part of the light reflecting surface 133a of the light guide member 130 bonded to the suspension member 160.

This configuration makes it possible to suppress reduction in efficiency of utilization of light, the reduction caused by the suspension member 160, even when the suspension member 160 is provided in order to increase the adhesive strength between the light guide member 130 and the triangular prism 150.

### Fourth Embodiment

Hereinafter, a fourth embodiment of the present invention will be described with reference to the drawings. Note that a description will be provided mainly for different points between the second and fourth embodiments.

Specifically, although the outer shape of the suspension member 160 has not particularly been described in the aforementioned second embodiment, the outer shape of a suspension member 160 will be described in the fourth embodiment.

(Outer Shape of Suspension Member)

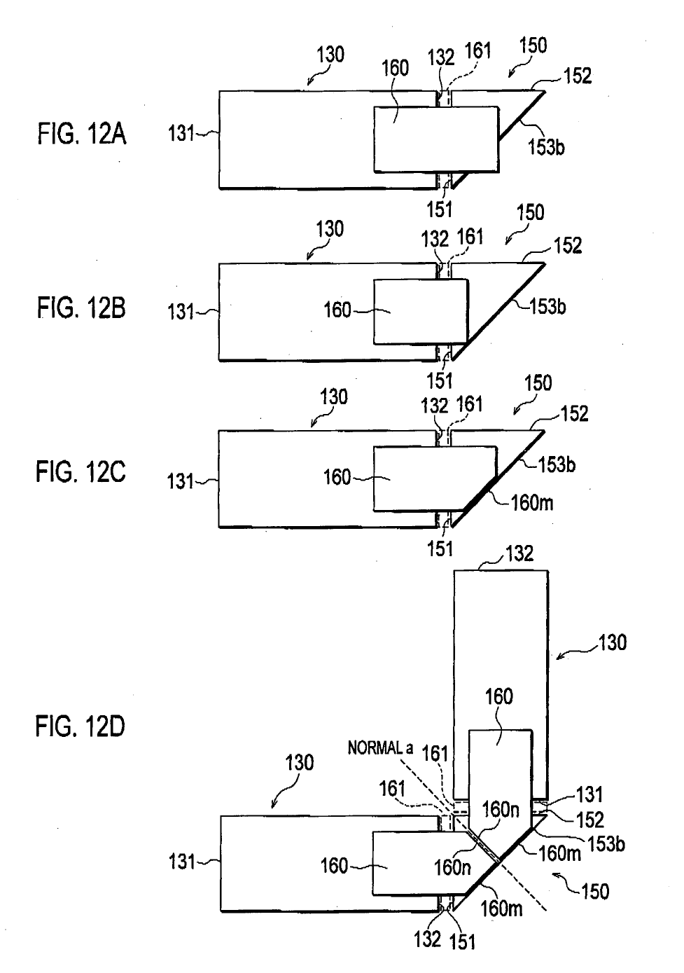

The outer shape of the suspension member according to the fourth embodiment of the present invention will be described below with reference to the drawings. FIGS. 12A to 12D are diagrams showing variations of the outer shape of the suspension member 160 according to the fourth embodiment of the present invention. Note that each of FIGS. 12A to 12D is a diagram showing the configuration of an optical member unit in a projection plane parallel to an adhesive surface 160a of the suspension member 160.

Moreover, as is similar to the aforementioned second embodiment, the optical member unit includes a light guide member 130, a triangular prism 150 and the suspension member 160 suspending the light guide member 130 and the triangular prism 150. In addition, an air gap 161 is provided between a light output surface 132 of the light guide member 130 and a light incident surface 151 of the triangular prism 150.

The suspension member 160 shown in FIG. 12A has a rectangular shape in the projection plane parallel to the adhesive surface 160a of the suspension member 160, and a part of the suspension member 160 protrudes outward from the edge of a light reflecting surface 153b of the triangular prism 150.

This configuration allows the adhesive surface 160a to have a sufficiently large area bonded to the triangular prism 150, since the part of the suspension member 160 protrudes outward from the edge of the triangular prism 150. On the other hand, the part of the suspension member 160 may be an obstacle to a manufacturing process of incorporating the optical member unit into the image display 100. Moreover, the suspension member 160 is likely to be damaged during the manufacturing process.

The suspension member 160 shown in FIG. 12B has a rectangular shape in the projection plane parallel to the adhesive surface 160a of the suspension member 160, and is disposed so as not to protrude outward from the edge of the light reflecting surface 153b of the triangular prism 150.

This configuration makes it easier to carry out the manufacturing process of incorporating the optical member unit into the image display 100, and also reduces the possibility that the suspension member 160 will be damaged. On the other hand, a reduction in the area of the adhesive surface 160a bonded to the triangular prism 150 results in a decrease in the adhesive strength between the triangular prism 150 and the suspension member 160.

The suspension member 160 shown in FIG. 12C has a side 160m along the light reflecting surface 153b (the light reflecting oblique face) of the triangular prism 150 in the projection plane parallel to the adhesive surface 160a of the suspension member 160.

Since the suspension member 160 has the side 160m along the light reflecting surface 153b (the light reflecting oblique face) of the triangular prism 150 as described above, the adhesive surface 160a is allowed to have a sufficiently large area bonded to the triangular prism 150. Moreover, this configuration makes it easier to carry out the manufacturing process for incorporating the optical member unit into the image display 100, and also reduces the possibility that the suspension member 160 will be damaged.

The suspension member 160 shown in FIG. 12D has a side 160m along the light reflecting surface 153b (the light reflecting oblique face) of the triangular prism 150, and a side 160n along a normal a to the light reflecting surface 153b (the light reflecting oblique face) of the triangular prism 150, in the projection plane parallel to the adhesive surface 160a of the suspension member 160.

Accordingly, even when a plurality of light guide members 30 are respectively disposed at the light incident surface 151 of the triangular prism 150, and at light output surface 152 thereof with air gaps 161 interposed in between, a plurality of suspension members 160 each suspending one of the light guide members 130 and the triangular prism 150 do not interfere with each other, as shown in FIG. 12D. Moreover, this configuration allows the adhesive surface 160a to have a sufficiently large area bonded to the triangular prism 150.

Note that the side 160n only needs to be along the normal a. More precisely, the side 160n may neither overlap with the normal a collinearly, nor be parallel to the normal a.

In addition, a corner of the side 160m and the side 160n may be rounded. Also, the suspension member 160 may have a shape in which a portion near the corner of the side 160m and the side 160n is removed.

Incidentally, it is preferable that the normal a be a line passing through an approximately central part of the light reflecting surface 153b (the light reflecting oblique face) of the triangular prism 150 in the projection plane parallel to the adhesive surface 160a of the suspension member 160.

From the point of view of the adhesive strength between the triangular prism 150 and the suspension member 160, and of ease in the manufacturing process of incorporating the optical member unit into the image display 100 as described above, it is effective to employ a shape shown in FIG. 12C or 12D for the suspension member 160. In a case where the plurality of light guide members 130 are disposed at the light incident surface 151 and the light output surface 152 of the triangular prism 150, it is particularly effective to employ the shape shown in FIG. 12D for the suspension member 160.

### Other Embodiments

Although the present invention has been described by using the aforementioned embodiments, it must not be understood that the descriptions and the drawings constituting part of this disclosure limit the present invention. Various alternative embodiments, implementation examples and applied techniques are obvious to those skilled in the art.

For example, the region with the low refractive index provided between the light output surface 132 of the light guide member 130 and the light incident surface 151 of the triangular prism 150 is described as the air gap 161 composed of the air in the aforementioned embodiments. However, the region is not limited to such an air gap.

More precisely, the region with the low refractive index may be configured by filling into the air gap 161a light transmitting material with the refractive index lower than those of the light guide member 130 and the triangular prism 150.

Incidentally, a transparent resin such as an acrylic resin and a polycarbonate resin, and an adhesive with the low refractive index are examples of the light transmitting material with the refractive index lower than those of the light guide member 130 and the triangular prism 150.

When the region with the low refractive index is formed in this way by filling into the air gap 161 the light transmitting material with the refractive index lower than those of the light guide member 130 and the triangular prism 150, it is possible to prevent a foreign substance such as dust from entering the space between the light output surface 132 of the light guide member 130 and the light incident surface 151 of the triangular prism 150.

Moreover, if an adhesive with the low refractive index is used as the light transmitting material with the refractive index lower than those of the light guide member 130 and the triangular prism 150, the adhesive strength between the light guide member 130 and the triangular prism 150 can be further increased.

In addition, although the air gap 161 is provided between the light output surface 132 of the light guide member 130 and the light incident surface 151 of the triangular prism 150 in the aforementioned embodiments, the position of the air gap 161 is not limited to this. Specifically, an air gap may be provided between the light output surface of the triangular prism and the light incident surface of the light guide member.

Furthermore, although the optical member unit is configured of the light guide member 130 and the triangular prism 150 in the aforementioned embodiments, the configuration of the optical member unit is not limited to this. Precisely, the optical member unit may be configured of two triangular prisms.

Moreover, the optical member unit in the aforementioned embodiments includes the optical member of changing the light progress direction of green light emitted from the light source 110g, but the optical member is not limited to this. The optical member unit may include an optical member of changing the light progress direction of red light emitted from the light source 110r, or an optical member of changing the light progress direction of blue light emitted from the light source 110b. Also, the optical member unit may include an optical member of changing the light progress direction of combined light of a plurality of colors, or an optical member of changing the light progress direction of light of a complementary color (for example, yellow).

Then, the liquid crystal panel 140 is used as the light modulation element in the aforementioned embodiments, but the light modulation element is not limited to this. A digital micro mirror device (DMD) or a reflection-type liquid crystal panel may be used as the light modulation element.

In addition, the light guide member 130 has the quadrangular pole shape in the aforementioned embodiments. However, the shape thereof is not limited to this, but a cylindrical shape or a polygonal columnar shape may be adopted. Similarly, although the light guide member 130 has the triangular pole shape in the aforementioned embodiments, the shape thereof is not limited to this, but a cylindrical shape or a polygonal columnar shape may be adopted.

The suspension member 160 is composed of the same kind of material as those of the light guide member 130 and the triangular prism 150, the material for the suspension member 160 is not limited to this. The suspension member 160 may be composed of a different kind of material.

Further, although a LED array of each color is included in one of the light sources 110 in the aforementioned embodiments, the light source 110 does not necessarily include such a LED array, but may include a single LED of each color.

Furthermore, it is possible to chamfer the edges of the optical member such as the tapered rods 120, the light guide members 130, the triangular prism 150 and the suspension member 160 in the aforementioned embodiments.

Still furthermore, the triangular prism 150 folds the light progress direction of light by totally reflecting the light by the light reflecting surface 153b, this changing mechanism is not limited to this. For example, the triangular prism 150 may have a configuration including, as a mirror face, a light reflecting surface 153b prepared by evaporating aluminum thereonto.

What is claimed is:

1. An optical member unit comprising: a light transmitting member configured to fold light emitted from a light source, and configured to guide the light into an imaging optics system, wherein,
the light transmitting member has a refractive index achieves total reflection of a part of light entering the imaging optics system, the incident angle of the part of light is within the maximum effective incident angle of the light to the imaging optics system, and
the maximum effective incident angle is determined by the imaging optics system and the refractive index of an incident-side medium provided between the imaging optics system and the optical member unit.

2. The optical member unit according to claim 1, wherein
the light transmitting member comprises a reflecting surface configured to reflect light, and an output surface through which the light reflected by the reflecting surface exits, and
assuming that:
nt denotes the refractive index of the light transmitting member;
na denotes the refractive index of an outer region outside the light transmitting member;
ni denotes the refractive index of the incident-side medium;
θi denotes the maximum effective incident angle;
θr denotes an incident angle of the light to the output surface;
β denotes the angle between the reflecting surface and the output surface;
a negative direction denotes a direction in which the light having a reflection angle smaller than an angle Δ is reflected in a plane perpendicular both to the reflecting surface and to the output surface, the reflection angle formed between a direction parallel to the optical axis of the light entering the imaging optics system and a direction of a normal to the reflecting surface, the angle Δ formed between the components in the perpendicular plane;
a positive direction denotes a direction in which the light having the reflection angle larger than the angle Δ is reflected;
an orthogonal direction denotes a direction of a normal to the imaging optics system; and
two conditional inequalities, nt>na and nt>ni are satisfied,
the light entering the imaging optics system in the positive direction satisfies the conditional inequality nt×sin(sin−1((ni/nt)×sin θi)+β)/na≧sin 90° when θr<(90−β)°,
the light entering the imaging optics system in the orthogonal direction satisfies the conditional inequality nt×sin β/na≧sin 90°, and
the light entering the imaging optics system in the negative direction satisfies the conditional inequality nt×sin(sin−1((ni/nt)×sin θi)−β)/na≧sin 90° when θr<β°.

3. The optical member unit according to claim 2, wherein the refractive index nt of the light transmitting member satisfies the conditional inequality, nt≧1.59597.

4. The optical member unit according to claim 1, comprising:
a first optical member having a first light incident surface, a first light output surface and a first light reflecting surface, and composed of a light transmitting material;
a second optical member having a second light incident surface, a second light output surface and a second light reflecting surface, and composed of a light transmitting material;
a low refractive index region forming member which is bonded to a part of an outer periphery of the first light output surface, and a part of an outer periphery of the second light incident surface, and which is configured to form a low refractive index region having a refractive index lower than those of the first optical member and the second optical member; and
a suspension member which has an adhesive surface bonded to a part of the first light reflecting surface and a part of the second light reflecting surface, and which is configured to suspend the first optical member and the second optical member, wherein
at least one of the first optical member and the second optical member folds a light progress direction from a light incident direction to a light outgoing direction different from the light incident direction, and
the suspension member reflects light having passed through the part of the first light reflecting surface.

5. The optical member unit according to claim 4, wherein the suspension member is composed of any one of a glass and a transparent resin.

6. The optical member unit according to claim 5, wherein the suspension member is composed of the same kind of material as those of the first optical member and the second optical member.

7. The optical member unit according to claim 4, wherein the adhesive surface of the suspension member is a mirror surface reflecting light having passed through any one of the first and second light reflecting surfaces.

8. The optical member unit according to claim 4, wherein
the first optical member is a light guide member having a quadrangular pole shape, and
the second optical member is a triangular prism having a triangular pole shape.

9. The optical member unit according to claim 8, wherein
the triangular prism has a light reflecting oblique face configured to guide light entering from the second light incident surface into the second light output surface by changing the light progress direction of the light, and
the suspension member has a side along the light reflecting oblique face in a projection plane parallel to the adhesive surface.

10. The optical member unit according to claim 9, wherein the suspension member has a side along a normal to the light reflecting oblique face in the projection plane parallel to the adhesive surface.

11. An optical member unit comprising:
a first optical member having a first light incident surface, a first light output surface and a first light reflecting surface, and composed of a light transmitting material;
a second optical member having a second light incident surface, a second light output surface and a second light reflecting surface, and composed of a light transmitting material;
a low refractive index region forming member which is bonded to a part of an outer periphery of the first light output surface, and a part of an outer periphery of the second light incident surface, and which forms a low refractive index region having a refractive index lower than those of the first optical member and the second optical member; and
a suspension member which has an adhesive surface bonded to a part of the first light reflecting surface and a part of the second light reflecting surface, and which suspends the first optical member and the second optical member, wherein
at least one of the first optical member and the second optical member folds a light progress direction from a light incident direction to a light outgoing direction different from the light incident direction, and
the suspension member reflects light having passed through the part of the first light reflecting surface.

12. An image display comprising the optical member unit according to claim 1.

13. An image display comprising the optical member unit according to claim 11.
